(19) United States
(12) Patent Application Publication
(10) Pub. No.: US 2004/0103699 A1
(43) Pub. Date: Jun. 3, 2004

(54) Lock for locking high pressure wind tube joint and fluid tube joint

(76) Inventor: I-Hui Ho, Taipei (TW)

Correspondence Address: I-Hui Ho, 235 Chung - Ho, Box 8-24, Taipei, TW

(21) Appl. No.: 10/342,472

(22) Filed: Jan. 8, 2003

(30) Foreign Application Priority Data
Dec. 3, 2002 (TW) 091219588

(51) Int. Cl. E05B 73/00

(52) U.S. Cl. 70/14

(57) ABSTRACT

A lock serves for locking a high pressure wind tube joint and a fluid tube joint. The lock comprises a casing for enclosing a housing of the wind tube joint; a lock body locking to the casing; and a core portion fixed to the lock body. Connecting ends of the high pressure wind tube joint and the fluid tube joint are located in the casing; then a stud of the core portion is inserted into the connecting ends so that the high pressure wind tube joint and fluid tube joint are combined with the casing. The casing is a seal body with only one opening. The core portion further includes a cover fixed in the lock body by a pin, a sleeve locked in the cover by a short pin, a stud below the sleeve, a spring at a periphery of the stud and pressed by the sleeve.

### FIELD OF THE INVENTION

The present invention relates to lock devices, and particularly to a lock of locking a high pressure wind tube joint and a fluid tube joint.

### BACKGROUND OF THE INVENTION

In the prior art, the ends of a high pressure wind tube joint and a fluid tube joint are formed with joints so that air or fluid can flow between two tubes. This is used in container cars, trailers, or plants necessary to connect air pressure or fluid. Referring to FIG. 1, a container car is used as an example. In the drawing, each of the head 11 of the container car and the container dray has a respective high pressure wind tube joint. The high pressure wind tube joints have joints 21, 22, as shown in FIG. 2. For connecting the joints 21 and 23, the connecting ends 23 and 24 must match to one another (referring to FIG. 3) so that tightening rubber rings 25 and 26 of the two connecting ends are compressed for preventing air or fluid from draining out. Thereby, air can flow from one tube to another tube so that air pressure braking can be performed.

In the connection of the head 11 and the container dray 12, a pull 1 at the head is buckled to a pull pin 2. Since the container dray is often stolen. Thereby, in one improvement, a lock is used to lock the pin 12. Namely, a lock is locked to a lower end of the pull pin 2 so as to enlarge the diameter of the pull pin 2. Since the pull 1 at the head has a U shape opening which has a size smaller than the widened pull pin 2, the pull 1 can be buckled to the pull pin 2. Thereby, the head can not be connected to the container dray. Therefore, the container dray will not be stolen.

It has found that in above prior art, when the container dray 12 is risen by a jack. The pull 1 of the head 11 will move backwards to be exactly below the pull pin 2. After alignment, the dray 12 is descended so that the whole pull pin 2 is contained in the pull 1. Thereby, the container dray 12 will be stolen.

### SUMMARY OF THE INVENTION

Accordingly, the primary object of the present invention is to provide a lock for locking a high pressure wind tube joint and a fluid tube joint. The lock comprises a casing for enclosing a housing of the wind tube joint; a lock body locking to the casing; and a core portion fixed to the lock body. By above assembly, connecting ends of the high pressure wind tube joint and the fluid tube joint are located in the casing; then the a stud of the core portion is inserted into the connecting ends so that the high pressure wind tube joint and fluid tube joint are combined with the casing.

Another object of the present invention is to provide a lock for locking a high pressure wind tube joint and a fluid tube joint, wherein the casing is a seal body with only one opening. The core portion further includes a cover fixed in the lock body by a pin, a sleeve locked in the cover by a short pin, a stud below the sleeve, a spring at a periphery of the stud and pressed by the sleeve. The sleeve has a hook; and an inner wall of the cover has a hook groove which has a configuration with respect to the hook of the sleeve.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention, wherein the car head of the container car is separated from the container.

FIG. 2 shows is a perspective view includes the high pressure wind tube joint of the container car of FIG. 1.

FIG. 3 is a cross sectional view showing that two joints of FIG. 2 are assembled.

FIG. 4 shows the assembly of the lock and high pressure wind tube joint of the present invention.

FIG. 5 is a perspective view showing the lock of the present invention is assembled with a high pressure wind tube joint.

FIG. 6 is a cross sectional view showing the lock of the present invention and the high pressure wind tube joint which are detached.

FIG. 7 is a cross sectional view showing the lock of the present invention and the high pressure wind tube joint which are assembled.

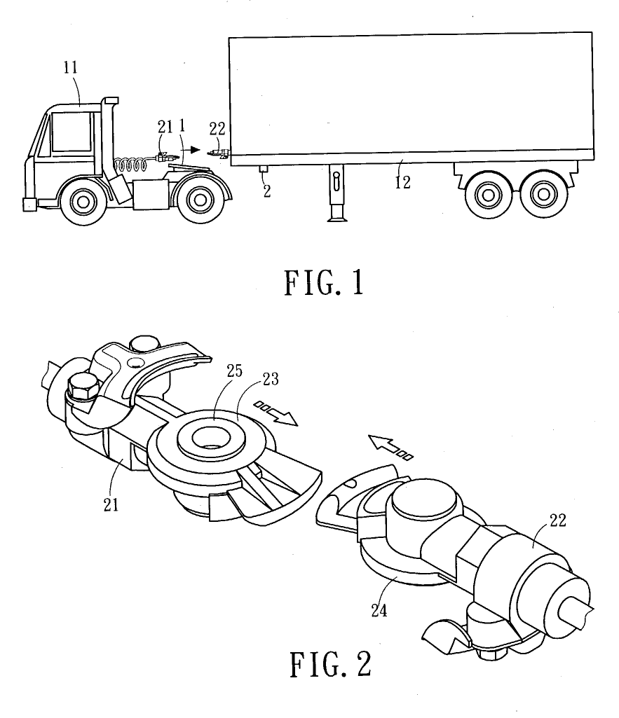

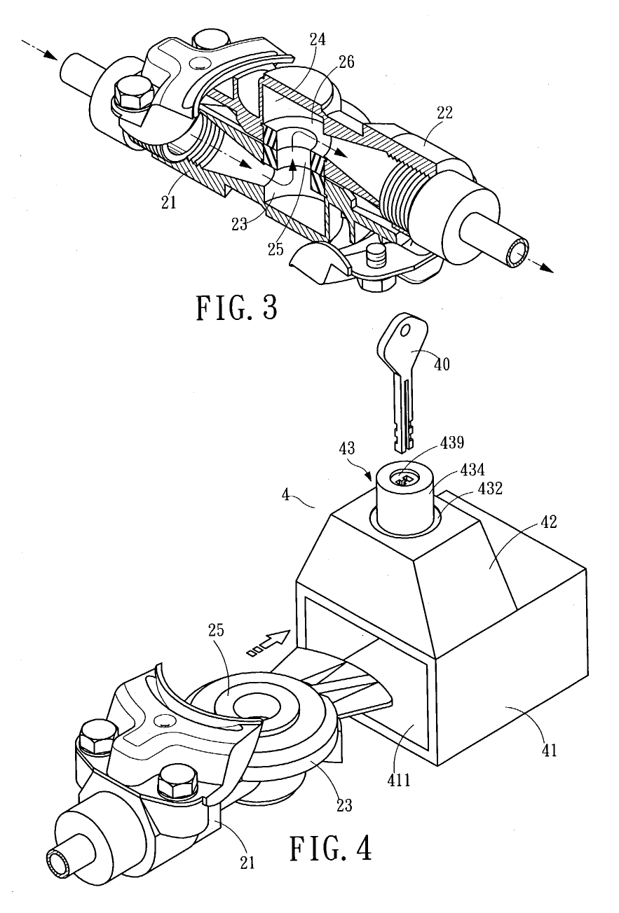

### BRIEF DESCRIPTION OF THE PREFERRED EMBODIMENTS

The embodiment of the present invention will be described herein with the appended drawings. However, the present invention is not confined by the embodiment. The present invention can be realized by other modifications and variations from these embodiments, which are also within the scope and spirit of the present invention.

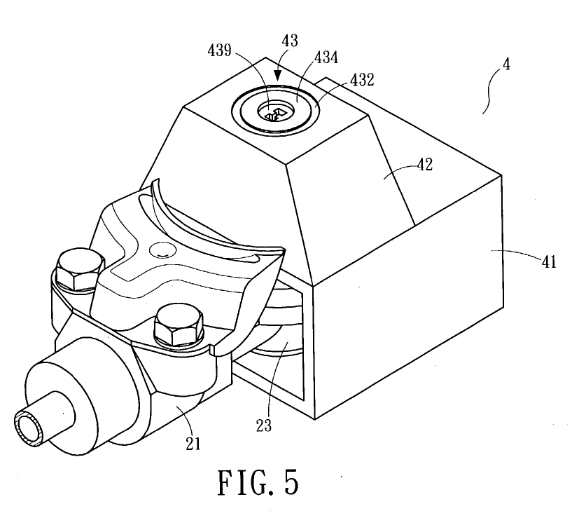

With reference to FIG. 4, the lock 4 of the present invention includes a casing 41, a lock body 42 integrally formed to the casing 41, a core portion 43 fixed to the lock body 42. The casing 41 is a seal body having one opening. The opening 411 is one side and other sides of the casing 41 are tightly sealed. The opening 411 can be inserted by the connecting end 23 of the joint 21 and thus the casing 41 encloses the lock body 42, as shown in FIG. 5. The lock body 42 is thick and can be integrally formed with the casing 41. Since the structure is concrete, it can not be destroyed by thieves.

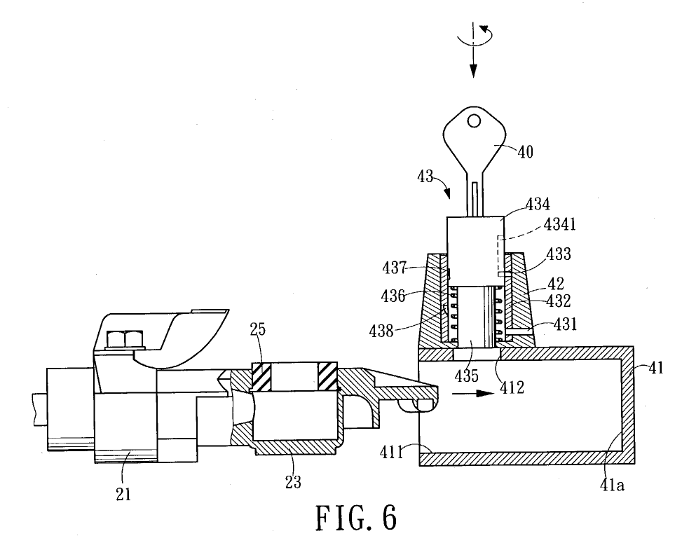

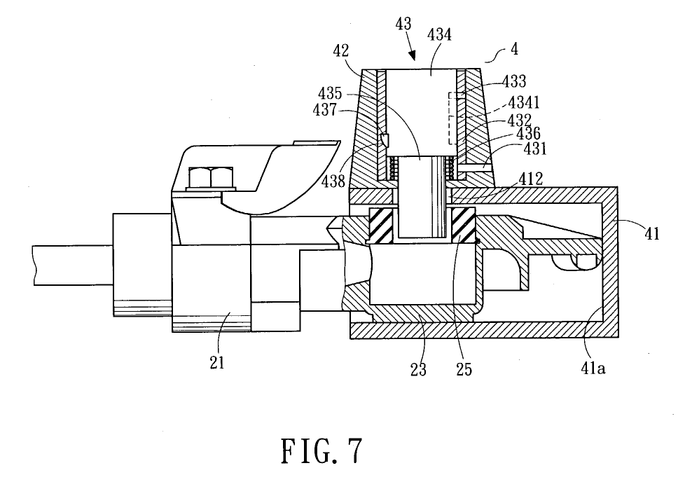

Referring to FIG. 6, a whole cross sectional view of the lock 4 of the present invention is illustrated. The core portion 43 further includes a cover 432 fixed in the lock body 42 by a pin 31, a sleeve 434 locked in the cover 432 by a short pin 433 (the short pin 433 is further inserted into the guide groove 4341 of the sleeve 434), a stud 435 below the sleeve 434, a spring 436 at a periphery of the stud 435 and pressed by the sleeve 434. Before operating the core portion 43, the sleeve 434 rises by the resilient force of the spring 436. Since the guide groove 4341 is confined by the short pin 433, the sleeve 434 will be placed above the cover 432 and only a part of the sleeve 434 protrudes out. At this time, the stud 435 is at a through hole 412 at a top of the casing 41 and thus the casing 41 is hollow. Thereby, the connecting end 23 at a front end of the joint 21 can be inserted into the casing 41 until a front edge of the connecting end 23 touches an inner wall 41a of the casing 41, as shown in FIG. 7.

Referring to FIG. 7, when the tightening rubber ring 25 at the connecting end of the joint 21 is aligned to the through hole 412 of the casing 41. An operator can press the core portion 43 downwards so that the stud 435 passes through the through hole 412 to be in the tightening rubber ring 25. When a hook 437 at a lateral wall of the sleeve 434 is guided into a hook groove 438 in the inner wall of the cover 432, since the hook 437 is fixed by the hook groove 438, the sleeve 434 can not move upwards again. Therefore, the stud 435 will fix the joint 21 so that it can not separate from the casing 41.

Further, in FIG. 6, the key 40 is inserted into the sleeve 434. The teeth of the key are matched to a plurality of lock pieces 439 and then the key is rotated to open the lock. Then the hook 436 can be reduced into the sleeve 434. Then by the resilient action of the spring 436, the stud 435 rises to separate from the rubber ring 25. Thereby, the joint 21 separates from the casing 41.

In above description, the lock body 42 and core portion 43 are at the casing 41 so that the stud 435 is vertically inserted into the rubber ring 25 of the joint 21. However, the present invention is not confined-by this way. Other similar way can be adapted. For example, the lock body 42 and core portion 43 are transversally installed on the casing 41 or a lateral side thereof. Except of stud 435, other means can be used to fix the joint 21. Many related arts can be used. However, it is only necessary that the connecting end 23 of the joint 21 is enclosed by the casing 41, and has no relation to the variation of the core portion 43 which is known in the prior art. In summary, the core portion 43 encloses the high pressure joint 21 tightly. Then a locking element, for example, the core portion 4.3, is inserted into the lock opening of the joint 21 so that the joint 21 and the casing 41 are undetached.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A lock for locking a high pressure wind tube joint and a fluid tube joint comprising:
a casing for enclosing a housing of the wind tube joint;
a lock body locking to the casing; and
a core portion fixed to the lock body;
wherein by above components, connecting ends of the high pressure wind tube joint and the fluid tube joint are located in the casing; then the a stud of the core portion is inserted into the connecting ends so that the high pressure wind tube joint and fluid tube joint are combined with the casing.

2. The lock for locking a high pressure wind tube joint and a fluid tube joint as claimed in claim 1, wherein the casing is a seal body with only one opening.

3. The lock for locking a high pressure wind tube joint and a fluid tube joint as claimed in claim 1, wherein the core portion further includes a cover fixed in the lock body by a pin, a sleeve locked in the cover by a short pin, a stud below the sleeve, a spring at a periphery of the stud and pressed by the sleeve; the sleeve has a hook; and an inner wall of the cover has a hook groove which has a configuration with respect to the hook of the sleeve.

4. The lock for locking a high pressure wind tube joint and a fluid tube joint as claimed in claim 3, wherein the sleeve has a plurality of lock pieces which is matched to teeth of the lock.
